(19) United States
(12) Patent Application Publication
(10) Pub. No.: US 2007/0115700 A1
(43) Pub. Date: May 24, 2007

(54) Transformer with current sensing means

(76) Inventor: Nigel Springett, Emmendingen (DE)

Correspondence Address: GALLAGHER & KENNEDY, P. A., 2575 E. CAMELBACK RD. #1100, PHOENIX, AZ, 85016, US

(21) Appl. No.: 11/592,472

(22) Filed: Nov. 2, 2006

(30) Foreign Application Priority Data
Nov. 2, 2005 (EP) EP 05 405 619.7

(51) Int. Cl. H02M 3/335

(52) U.S. Cl. 363/24

(57) ABSTRACT

A power transformer for a power converter includes a magnetic core, a primary winding and two serially connected secondary windings. In order to sense the output current to generate therefrom a control signal for controlling a switching of the synchronous rectifiers of the power converter, the power transformer includes an integrated current transformer with a ring-type core and a secondary winding. The primary windings of the current transformer are formed by the end portions of the secondary windings that are fed through the ring-type core. Accordingly, the end portions form a turn of the secondary windings of the main transformer as well as a turn of the primary winding of the current transformer. Accordingly, only one current transformer is needed, which means lower costs and less space required, and the losses due to the wiring to and from the current transformer can be eliminated.

### FIELD OF THE INVENTION

The invention relates to a main transformer for a power supply having at least one transformer winding and means for sensing a current in said at least one transformer winding. The invention further relates to a power supply with such a main transformer, a controllable switching device and a control circuit that is coupled to said controllable switching device for controlling the switching device, where said means for sensing a current in said at least one transformer winding is coupled to said control circuit.

### BACKGROUND

In power circuitry, power switches are among the key contributors to overall power loss. It is therefore an aim of power supply designers to minimize the losses arising from non-zero currents and voltages across the switching devices while the switching action is performed. Among the switching devices used are rectifier diodes and synchronous rectifiers.

Rectifier diodes have the advantage that they are simple to design into a power supply. They are inserted into the power circuit and the voltage across the power train windings will force the diode to commutate when it is appropriate. Because of their simplicity, diode rectifiers are cheap and easy to incorporate into a given circuit. While offering a simple rectifier design, diode rectifiers have several downsides, e.g. diodes have a fixed forward voltage drop that is independent of the current. This results in high levels of power dissipation, especially at high current levels. When the efficiency of diode rectifiers is calculated for various output voltages, they are found to be efficient at high output voltages, but as the output voltage drops, the efficiency of diode rectifiers drops precipitously.

For high current applications, synchronous rectification is preferred over rectification by discrete diodes due to the high conduction losses associated. Synchronous rectifiers are e.g. MOSFETs (metal oxide semiconductor field effect transistor), bipolar transistors or other semiconductor switches driven in such a way as to perform a rectifying function. Synchronous rectifiers, however, have the disadvantage that the switching action of the synchronous rectifiers needs to be actively controlled by an additional circuit. In power circuits, synchronous rectifiers are therefore often complicated to use because of timing issues. Whereas some methods use hard-switching techniques, soft switching or zero voltage/current switching has become widely spread due to the lower switching losses.

In order to predict the correct timing by the latter method, current sensing devices are needed to provide the controlling circuit of the switches with accurate information about the current in the circuit. Thereby, it is very important that the current is determined with a high accuracy in order to minimize losses.

In the case of transformers with a push-pull output stage, which are typically used in high power applications, two current transformers, each connected to one of the two serially connected, secondary windings of the transformer, are typically needed to properly control the synchronous rectifiers. But two current transformers not only raise the manufacturing costs of such a converter, for example due to the increased number of components, in high current applications there are also significant losses that occur in the wiring to and from the current transformers. Furthermore, the current sensing may be incorrect due to the magnetizing current in the current transformers and, in addition, the two current transformers need a lot of space.

Another possibility for current sensing is a sense resistor (also called current shunt). However, such resistors cause additional losses due to their voltage drop. Furthermore, they are too inaccurate in their current sensing. In order to improve the accuracy of such a resistive device, for example in a push-pull output stage, where such a sense resistor is provided in the common path of the two secondary windings, the resistor is combined with a precision OPAMP (operational amplifier). But these devices are rather expensive.

### BRIEF DESCRIPTION

It is an object of the invention to create a main transformer assembly (hereinafter also referred to as transformer) of a power supply as well as a power supply pertaining to the technical field initially mentioned that enables to overcome or reduce the disadvantages of the prior art and particularly to enable the design of low loss, small and cheap transformer arrangements with current sensing device.

According to the invention the main transformer for a power supply has at least one transformer winding as well as means for sensing the current in this at least one transformer winding. The invention is wherein the means for sensing the current in the at least one transformer winding include a single current sensing device that is integrated into the main transformer.

In addition to such a main transformer, a power supply according to the invention further includes a controllable switching device and a control circuit that is coupled to the controllable switching device for controlling the switching of the switching device. In order to provide the result of the current sensing to the control circuit which may then generate a control signal for controlling the switching device, the means for sensing the current in the transformer winding are coupled to the control circuit.

By integrating the current sensing device into the main transformer there is no wiring to and from the current sensing device as in the prior art converters. Accordingly, in high current applications the losses engendered can be virtually eliminated which means that the overall losses can be significantly reduced. While a transformer with a current sensing device could generally be used in low power applications, high power applications are therefore preferred applications of a power supply according to the invention. In this connection, high power means power levels of some dozens of watts and above.

The invention further provides the possibility to sense the current with a high accuracy, for example, with an accuracy in the range of 1% to 2% or even lower than 1% over the whole load range.

Furthermore, the price for a power supply or a main transformer according to the invention is much lower than a comparable prior art design because a single current sensing device costs significantly less than two current sensing devices such as current transformer or a sense resistor with a precision OPAMP as needed in the prior art. Also the space requirements are reduced since one single current sensing device needs only about half of the space that two current transformers need.

The means of the term “integrated” in connection with the current sensing device is that the current transformer is not a separate element that is manufactured independently of the main transformer and connected to the main transformer at a later stage. It means that the current sensing device and the main transformer form a single unit. Preferably they are manufactured at the same time in a common process such that the current sensing device forms an integral, built-in or embedded part of the main transformer.

While the current sensing device could be a resistive device in combination with an OPAMP or any other device that enables a current measurement, the current sensing device preferably includes a current transformer. In this case, a primary winding of the current transformer is formed by a section of the at least one transformer winding of the main transformer and not by a junction wire that interconnects the transformer winding with another (preceding or subsequent) circuit of the power supply. In other words, the same portion of a conductor forms a section of the transformer winding as well as the primary winding of the current transformer. The primary current transformer winding and the winding of the main transformer have therefore at least one common (full or fractional) turn.

Such a current transformer shows low losses and is easy and therefore inexpensive to manufacture.

The current transformer further preferably includes a secondary winding and a magnetic core, particularly a ring-type core, which means that the core forms a closed loop such that the magnetic flux can circulate therein. By choosing an appropriate winding ratio—the number of windings of the secondary winding is, for example, much greater than the winding number of the primary winding—the current transformer can measure the high current flowing in the transformer winding by producing a much lower but proportional current in its secondary winding.

While said transformer winding can also be a primary winding of the main transformer, it is in a preferred embodiment of the invention a secondary winding of the main transformer. This is, for example, advantageous in a transformer with two serially connected secondary windings in a push-pull configuration, where the current in both secondary windings has to be measured in order to ensure an adequate current sensing.

During current sensing, the magnetizing inductance of the current transformer does not affect the average measured signal, which considerably improves the accuracy of the measurements.

In another preferred embodiment of the invention, the main transformer includes not only one but at least two secondary windings. In this case, the secondary windings are connected in series and a section of at least one of the secondary windings forms a primary winding of said current transformer. That is a section of only one secondary winding, a section of several secondary windings or a section of each secondary winding forms a primary winding of the current transformer.

While it would be possible that a center section of the at least one secondary transformer winding forms a primary winding of the current transformer, it is preferred that a primary winding of the current transformer is formed by an end portion of a secondary winding, which facilitates the winding process during manufacturing of the transformer.

It is also possible to apply the invention in a main transformer assembly that includes two or more transformer outputs. In this case, each transformer output includes at least one secondary transformer winding and each output includes current sensing means for sensing a current in this secondary winding of each transformer output. Again, these current sensing means include a single current sensing device that is integrated into the main transformer assembly.

The invention is preferably applied in a transformer with a push-pull output stage with two secondary windings connected in series. Accordingly, a section of the first secondary winding forms a primary winding of the current transformer and a section of the second secondary winding also forms a primary winding of the current transformer. In such a configuration the invention is of particular benefit, since it allows a considerable reduction of costs, losses and size in comparison with a conventional transformer having a push-pull output stage with two separate current transformers each connected to one secondary winding.

Nevertheless, the invention can also be used in other standard converter topologies such as, for example, forward, flyback, full-bridge, half-bridge, current or voltage fed and further push-pull converters as well as other converter topologies.

In a preferred embodiment of the power supply according to the invention, the current sensing device includes, as mentioned before, a secondary winding. This secondary winding is built for producing a current sense signal that depends on and is representative of the current in the transformer winding that forms the primary winding of the current transformer. The current transformer is further coupled to said control circuit such that the sense signal produced by the secondary current transformer winding is provided to the control circuit.

The controllable switching device can principally be of any known type of switch that can be controlled by applying a suitable control signal to a corresponding control input of the switching device. Preferably, the switching device includes a semiconductor switching device such as, for example, a MOSFET or a bipolar transistor where the control input is the gate of the transistor.

Although it would be possible that the switching device is a primary switch of a switched mode power supply, the switching device is preferably configured as a synchronous rectifier on a secondary side of the main transformer, which means it is a part of the rectifier of the power supply.

In order to control a switching of the controllable switching device, the control circuit preferably includes means for producing a control signal in dependency of the sense signal provided by the current transformer. Accordingly, the control signal is produced by the control circuit in dependency of the current flowing in the transformer winding a part of which forms the primary winding of the current transformer. The control circuit further includes means for providing the generated control signal to a control input of the switching device.

The invention is particularly suitable for power supplies with a resonant converter. So in a preferred embodiment of the invention, the power supply includes a resonant circuit. Advantageously, an inductance of the main transformer forms an inductance of this resonant circuit. In a non-resonant power supply with a continuous current flow it is not possible to apply the invention.

In an even more preferred embodiment, the resonant circuit is an output circuit of the power supply, particularly a LLC-type output circuit.

A winding of the main transformer includes, for example, a wire or a litze wire wound around a core of the main transformer.

In principle, it would also be possible to provide the main transformer with more than one integrated current transformer, for example, an additional current transformer on the primary side of the transformer. However, the space and cost requirements would be increased as well thereby nullifying some of the advantages of the invention.

It is further to note that the invention is not only suited for generating the input signals of a control circuit for controlling switching devices, it is well suited in every application where current (either the instantaneous current, the integrated current or other current properties) has to be sensed with a high accuracy, for example, in current output limiting devices, for status reporting of converter arrangements or for controlling the current sharing in converter arrangement with multiple converters connected in parallel.

The foregoing and other objects, features and advantages of the present invention will be more readily understood upon consideration of the following detailed description of the invention, taken in conjunction with the following drawings.

### BRIEF DESCRIPTION OF THE DRAWINGS

FIG. 1 is a schematic circuit diagram of a half-bridge converter with a push-pull output stage and an integrated current transformer according to the invention

FIG. 2 is a schematic, perspective view of a transformer with an integrated current transformer according to the invention;

FIG. 3 is a schematic, detailed, perspective view of an integrated current transformer according to the invention;

FIG. 4 is a schematic circuit diagram of a further embodiment of the invention where the current transformer is integrated at another position; and

FIG. 5 is a schematic circuit diagram of a transformer arrangement with two outputs where each output includes an integrated current transformer according to the invention.

### DETAILED DESCRIPTION

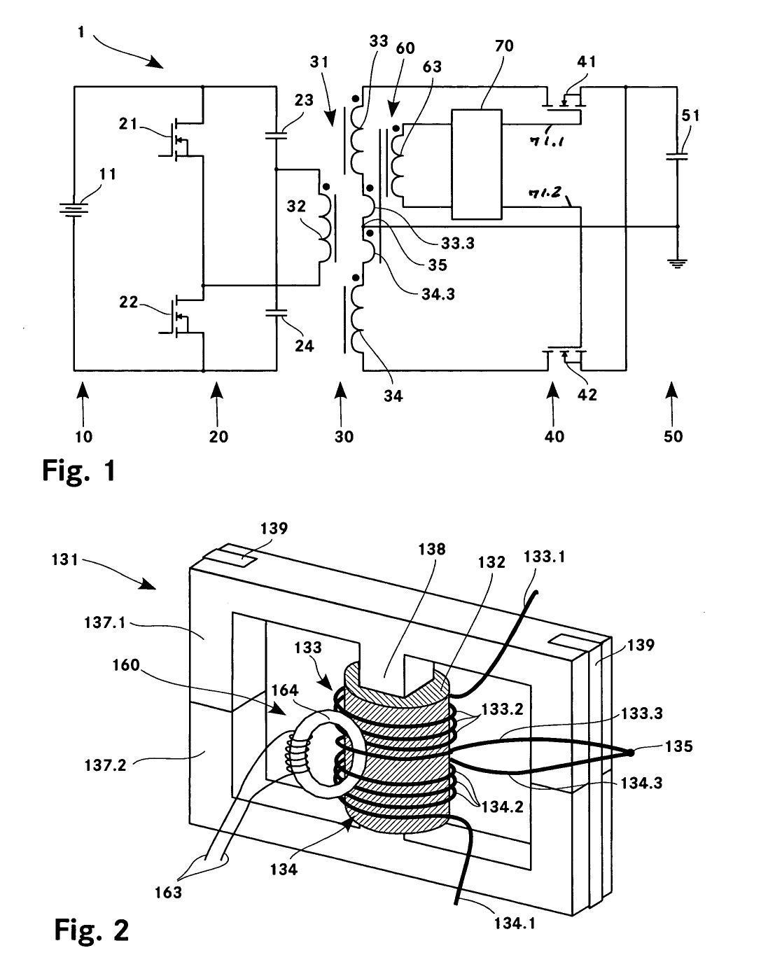

FIG. 1 shows a schematic circuit diagram of a half-bridge converter 1 with a push-pull output stage, an input circuit 10, a switching circuit 20, a transformer stage 30, a rectifier circuit 40 and an output circuit 50. The input circuit 10 includes a voltage source 11 that is connected to the single primary winding 32 of the main power transformer 31. The switching circuit 20 includes two controllable semiconductor switches 21, 22 and two capacitors 23, 24 in a half-bridge configuration. That is, a serial circuit of the two semiconductor switches 21, 22 is connected across the voltage source 11 and in parallel to a series circuit of the two capacitors 23, 24. Accordingly, the positive terminal of the voltage source 11 is connected to the first terminal of switch 21 as well as to the first terminal of capacitor 23. The negative terminal of the voltage source 11 is connected to the second terminal of switch 22 as well as to the second terminal of capacitor 24. The second terminal of switch 21 is connected to a first terminal of switch 22, and the second terminal of capacitor 23 is connected to the first terminal of capacitor 24. Then, this switching circuit 20 is connected to the primary winding 32 of the transformer 31 such that the common terminals of the capacitors 23, 24 are connected to the first terminal of the primary winding 32, and such that the common terminals of the switches 21, 22 are connected to the second terminal of the primary winding 32.

The transformer stage 30 includes in its secondary two serially connected secondary windings 33, 34 with a center tap 35. The rectifier circuit 40 includes two synchronous rectifiers 41, 42 and the output circuit 50 includes an output capacitor 51. The first terminal of the first secondary winding 33 is connected to the first terminal of the output capacitor 51 via the first synchronous rectifier 41 and the second terminal of the second secondary winding 34 is also connected to the first terminal of the output capacitor 51 via the second synchronous rectifier 42. The second terminal of the first secondary winding 33 as well as the first terminal of the second secondary winding 34 are connected to the center tap 35 which is connected to the second terminal of the output capacitor 51.

The converter further includes a current sensing device in its secondary. In the example shown, the current sensing device is a current transformer 60 that is integrated into the main transformer 31. Accordingly, an end portion 33.3 of the first secondary winding 33 of the main transformer 31 forms a primary winding of the current transformer 60, and an end portion 34.3 of the second secondary winding 34 of the main transformer 31 also forms a primary winding of the current transformer 60. The current transformer 60 further includes a secondary winding 63, both terminals of which are connected to an input of a control circuit 70. The control circuit 70 includes several outputs where each output provides a control signal 71.1, 71.2 to the control inputs of the synchronous rectifiers 41, 42 respectively.

With such a control circuit 70 or a similar control circuit, the converter 1 may, for example, be controlled in a resonant mode where zero current and/or zero voltage switching of the synchronous rectifiers 41, 42 can be achieved.

In the prior art, a power converter with a push-pull output stage included two current transformer, one in the connection between the first secondary winding and the first synchronous rectifier and one in the connection between the second secondary winding and the second synchronous rectifier. Accordingly, the invention cuts the number of necessary current transformers in half which results in lower costs, lower space requirements and lower losses. The losses can be lowered twice. First, there are no connecting lines necessary between the main transformer 31 and the current transformer 60, because the current transformer 60 is integrated into the main transformer 31 and therefore the losses in the wiring from and to the current transformer (this wiring makes up impedances that falsify the current sensings) is eliminated. Second, there is no extra leakage inductance introduced between the secondary windings as in the prior art. Furthermore, the current sensing accuracy is improved, since errors due to the magnetizing currents in the current transformers are eliminated or at least reduced. Measurements have shown that the errors in the current sensing are below one percent which means that the current can be measured with a high accuracy.

The overall result is a considerable increase of the converter's efficiency.

It is to note that the converter 1 may include further components and circuits as known in the art. However, for a better clarity, these components and circuits have not been shown in the drawings.

It would, for example, be possible to feed the converter 1 with an AC current or voltage and to provide a rectifier for rectification of such an AC input. A current transformer according to the invention could also be employed in other converter topologies as mentioned before. In other embodiments of the invention, the rectifier circuit could also include a single synchronous rectifier, a full bridge rectifier or other known rectifier circuits with synchronous rectifiers.

Furthermore, it is self-evident that the control circuit 70 can not only control a switching of the synchronous rectifiers 41, 42 in the secondary, but also the switching of the switches 21, 22 or other controllable switching devices as desired.

FIG. 2 shows a schematic, perspective view of a transformer 131 according to the invention. The transformer 131 includes a core that is made up of two E-type core halves 137.1, 137.2 that are, for example, clamped together by clamps 139. A primary winding 132 is wound around the middle leg 138. A first secondary winding 133 and a second secondary winding 134 are also wound around the middle leg 138, for example, on top of the primary winding 132. The first secondary winding 133 includes a first end portion 133.1 which is connected to a terminal (not shown), a center portion 133.2 which is wound directly around the middle leg 138 and a second end portion 133.3 which is fed through a ring-type core 164 and is then connected to a center tap 135. Accordingly the second secondary winding 134 includes a first end portion 134.1 which is connected to a terminal (not shown), a center portion 134.2 which is wound directly around the middle leg 138 and a second end portion 134.3 which is fed through the ring-type core 164 and is then connected to the center tap 135 too. Around the ring-type core 164 is wound a further winding, the secondary winding 163. The ring-type core 164, the primary windings 133.3 and 134.3 and the secondary winding 163 form the current transformer 160.

Hence, the end portions 133.3 and 134.3 of the first and second secondary windings 133, 134 form a turn of the secondary windings 133, 134 of the main transformer 131 as well as at the same time a turn of the primary windings of the current transformer 160. This means that the current transformer 160 is an integrated part of the main transformer 131.

A simple and therefore preferred way of providing the secondary windings (not shown in the drawings) is by winding a bifilar wire, for example, a litz wire, several times around the middle leg and finally once through the ring-type core 164 and then connecting the beginning of one of the conductors of the bifilar wire and the end of the other conductor of the bifilar wire to the center tap.

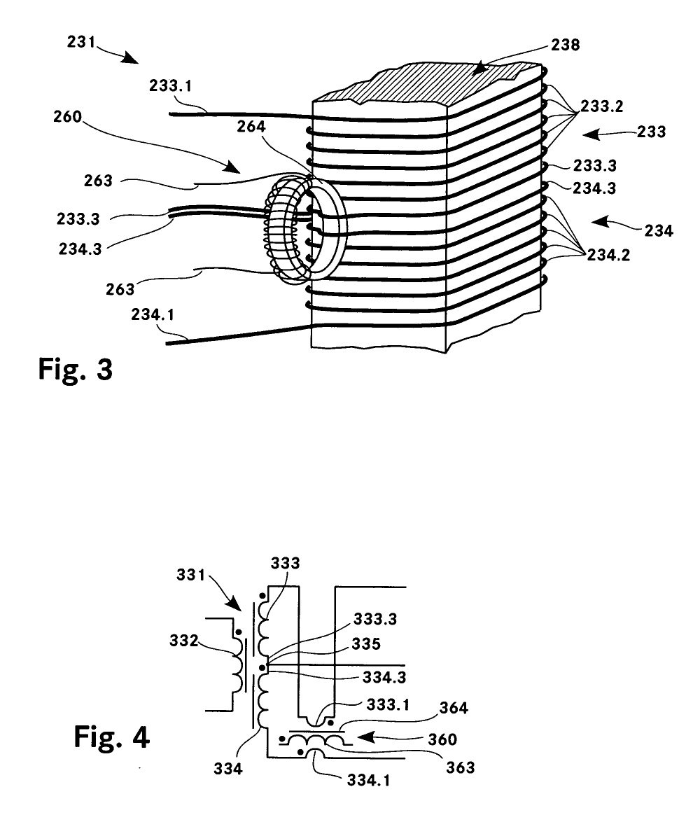

FIG. 3 shows a schematic, perspective view of another current transformer 260 integrated into one of the legs 238 of a main transformer 231. Again, the first secondary winding 233 includes a first end portion 233.1, a center portion 233.2 which is wound around the leg 238 and a second end portion 233.3 which is fed through the ring-type core 264 of the integrated current transformer 260 and forms a further turn of the secondary winding 233 as well as a turn of the primary winding of the current transformer 260. In the same manner, the second secondary winding 234 includes a first end portion 234.1, a center portion 234.2 which is wound around the leg 238 and a second end portion 234.3 which is fed through the ring-type core 264 and forms a further turn of the secondary winding 234 as well as a turn of the primary winding of the current transformer 260.

Again, the end portions 233.1, 234.1 are connected together to form the center tap (not shown). One of the differences to the transformer shown in FIG. 2 is that the primary winding of this transformer 231 is not wound around the same, but around another leg (not shown) of the transformer core.

While in both examples of FIGS. 2 and 3 only one turn of the secondary windings 133, 134, 233, 234 is shown to be fed through the ring-type core 164, 264, it is self evident that it is possible to feed also two or more turns of the secondary windings 133, 134, 233, 234 through the ring-type core 164, 264. However, since the current transformers 160, 260 are used for current measurements, it is desired that the current in the secondary winding 163, 263 is not too high. Therefore, the ratio of the number of turns of the primary windings 133, 134, 233, 234 to the number of turns of the secondary windings 163, 263 should be rather small, which means that the number of turns of the primary windings 133, 134, 233, 234 is chosen to be low (such as for example one turn as shown in the drawings) or that the number of turns of the secondary winding 163, 263 is chosen to be high.

It would further be possible to feed the end portions 133.1, 134.1 or 233.1, 234.1 through the ring-type core 164, 264 instead of the end portions 133.3, 134.3 or 233.3, 234.3 as shown in FIGS. 2 and 3. Another possibility to integrate the current transformer 160, 260 into the main transformer 131, 231 would be to feed the end portions 133.1, 233.1 and 134.3, 243.3 or 133.3, 233.3 and 134.1, 243.1 through the ring-type core 164. It would even be possible to feed one of the turns of the center portion 133.2, 233.2 through the ring-type core 164, 264, but this would be more complex to manufacture.

FIG. 4 shows the schematic electrical diagram of a further power transformer 331 according to the invention where not the end portions 333.3, 334.3, but the end portions 333.1 and 334.1 are fed through the ring-type core 364 of the current transformer 360. The end portions 333.3, 334.3 are connected together and form the center tap 335.

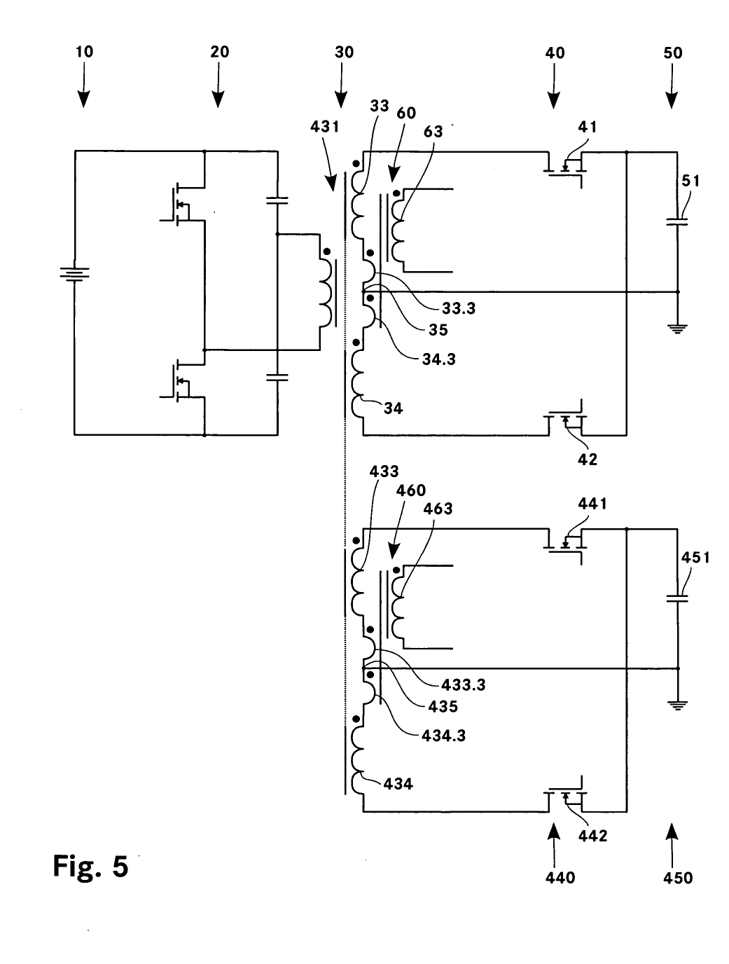

FIG. 5 shows a schematic circuit diagram of a transformer arrangement of a power supply with two outputs. The arrangement includes a primary side with an input circuit 10 and a switching circuit 20 that corresponds to the primary side of the converter 1 shown in FIG. 1. The transformer stage 30 includes a transformer 431 having four secondary windings 33, 34, 433, 434 where the secondary windings 33, 34 provide the secondary voltages for the first output of the transformer arrangement and the secondary windings 433, 434 provide the secondary voltages for the second output. The first output with rectifier circuit 40, output circuit 50 and current transformer 60 correspond to the secondary side of the converter 1 as shown in FIG. 1. No control circuit for controlling the switching of the switches of this transformer arrangement is shown.

The second output is of the push-pull type as well and is connected in parallel to the first output. It is similar or even identical to the first output and includes a rectifier circuit 440 with synchronous rectifiers 441, 442 and an output circuit 450 with output capacitor 451. The second output includes a further current transformer 460 that is integrated into the main transformer 431. An end portion 433.3 of the first secondary winding 433 of the main transformer 431 forms a primary winding of the current transformer 460 and an end portion 434.3 of the second secondary winding 434 also forms a primary winding of the current transformer 460. The current transformer 460 further includes a secondary winding 463 for providing a current signal representing the sensed current in the secondary windings 433, 434. Again, no control circuit for controlling the switching of the switches of this transformer arrangement is shown.

Control circuits that generate one of more control signals for controlling the synchronous rectifiers or other switches of such a transformer arrangement in dependency of the output current flowing in the secondary windings are well known in the art and are therefore not described here.

In summary, it is to be noted that the invention enables not only the design of cost effective and less space-demanding power transformers and power supplies but as well as transformers and power supplies with an improved efficiency, since several inaccuracies in the current measurement are eliminated or at least reduced.

Although preferred embodiments of the invention have been described in detail, it will be readily appreciated by those skilled in the art that further modifications, alterations and additions to the invention embodiments disclosed may be made without departure from the spirit and scope of the invention as set forth in the appended claims.

I claim:

1. A main transformer assembly for a power supply, having at least one transformer winding and means for sensing a current in said at least one transformer winding, wherein said means for sensing a current in said at least one transformer winding includes a single current sensing device that is integrated into a main transformer.

2. The main transformer assembly as claimed in claim 1, wherein said current sending device includes a current transformer, where a section of the at least one transformer winding of the main transformer forms a primary winding of said current transformer.

3. The main transformer assembly as claimed in claim 2, wherein said current transformer includes a secondary winding and a magnetic core.

4. The main transformer assembly as claimed in claim 3, wherein the magnetic core is a ring-type core.

5. The main transformer assembly as claimed in any one of claims 1-3, wherein said at least one transformer winding is a secondary winding of said main transformer.

6. The main transformer assembly as claimed in any one of claims 2, wherein said main transformer includes two or more secondary windings connected in series, where a section of at least one of said secondary windings forms a primary winding of said current transformer.

7. The main transformer assembly as claimed in claim 6, wherein an end portion of said at least one secondary windings forms a primary winding of said current transformer.

8. The main transformer assembly as claimed in any one of claims 1-3, wherein said main transformer assembly includes two or more transformer outputs, each transformer output including at least one secondary transformer winding and means for sensing a current in said at least one secondary transformer winding of each transformer output, where each means for sensing a current include a single current sensing device that is integrated into said main transformer assembly.

9. The main transformer assembly as claimed in any one of claims 2, wherein said main transformer assembly includes an output stage having a push-pull configuration with a first and a second secondary winding connected in series, where a section of the first secondary winding forms a primary winding of said current transformer and a section of the second secondary winding forms a primary winding of said current transformer.

10. A power supply with a main transformer assembly having at least one transformer winding and means for sensing a current in said at least one transformer winding as claimed in any one of claims 1 to 3, the power supply further including a controllable switching device and a control circuit that is coupled to said controllable switching device for controlling the switching device, where said means for sensing a current in said at least one transformer winding are coupled to said control circuit.

11. A power supply with a main transformer assembly having at least one transformer winding and means for sensing a current in said at least one transformer winding as claimed in claim 5, the power supply further including a controllable switching device and a control circuit that is coupled to said controllable switching device for controlling the switching device, where said means for sensing a current in said at least one transformer winding are coupled to said control circuit.

12. A power supply with a main transformer assembly having at least one transformer winding and means for sensing a current in said at least one transformer winding as claimed in claim 6, the power supply further including a controllable switching device and a control circuit that is coupled to said controllable switching device for controlling the switching device, where said means for sensing a current in said at least one transformer winding are coupled to said control circuit.

13. A power supply as claimed in claim 10, wherein the current sensing device further includes a secondary winding for producing a current sense signal and is coupled to said control circuit for providing said sense signal to said control circuit.

14. A power supply as claimed in claim 11, wherein the current sensing device further includes a secondary winding for producing a current sense signal and is coupled to said control circuit for providing said sense signal to said control circuit.

15. A power supply as claimed in claim 12, wherein the current sensing device further includes a secondary winding for producing a current sense signal and is coupled to said control circuit for providing said sense signal to said control circuit.

16. A power supply as claimed in claim 10, wherein said switching device includes a semiconductor switching device.

17. A power supply as claimed in claim 16, wherein said a semiconductor switching device comprises a synchronous rectifier on a secondary side of said main transformer assembly.

18. A power supply as claimed in claim 11, wherein said switching device includes a semiconductor switching device.

19. A power supply as claimed in claim 12, wherein said switching device includes a semiconductor switching device.

20. A power supply as claimed in claim 10, wherein said control circuit includes means for producing a control signal for controlling said switching device and providing said control signal to a control input of said switching device.

21. A power supply as claimed in claim 10, wherein the power supply includes a resonant circuit where an inductance of said main transformer forms an inductance of said resonant circuit.

22. A power supply as claimed in claim 21, wherein said resonant circuit is an output circuit.

23. A power supply as claimed in claim 22, wherein the output circuit is an LLC-type output circuit of said main transformer assembly.
